(19) United States
(12) Patent Application Publication
(10) Pub. No.: US 2013/0206245 A1
(43) Pub. Date: Aug. 15, 2013

(54) Device and Method For Use In Controlling Fluid Flow

(71) Applicants: Michael Clark, Danestone (GB); Grant Adams, Aberdeen (GB); Liam Watt Clark Goodall, Penicuik (GB); Annabel Green, Huntly (GB); Quentin Morgan, Murarrie (AU); Abdurrezagh Awid, Aberdeen (GB)

(72) Inventors: Michael Clark, Danestone (GB); Grant Adams, Aberdeen (GB); Liam Watt Clark Goodall, Penicuik (GB); Annabel Green, Huntly (GB); Quentin Morgan, Murarrie (AU); Abdurrezagh Awid, Aberdeen (GB)

(73) Assignee: WEATHERFORD/LAMB, INC., Houston, TX (US)

(21) Appl. No.: 13/593,354

(22) Filed: Aug. 23, 2012

(30) Foreign Application Priority Data
Feb. 13, 2012 (GB) 1202454.3

(51) Int. Cl. F16K 27/00

(52) U.S. Cl. 137/15.01; 137/315.01

(57) ABSTRACT

A flow control device comprises a housing, a flow restriction member, and a flow control ring defining a flow control port which is configured to receive the flow restriction member. The flow control ring is configured so as to be sealingly mounted onto a base pipe. The flow restriction member is at least partially inserted into the flow control port so as to at least partially define a predetermined flow restriction through the flow control ring. The housing is sealingly mounted on the flow control ring. The flow control device may be mounted on a base pipe. The flow control device may be used for controlling fluid flow, in particular, though not exclusively in oil and/or gas wells. A flow control system and method are also disclosed

### CROSS REFERENCE TO RELATED APPLICATIONS

This application claims priority to United Kingdom Patent Application Serial No. GB1202454.3 filed Feb. 13, 2012, the contents of which are incorporated herein by reference.

### FIELD OF THE INVENTION

Disclosed herein is a flow control device and method, in particular, though not exclusively, for use in controlling the flow of fluid from a subterranean hydrocarbon bearing formation into a base pipe for the production of oil and/or gas from a wellbore.

### BACKGROUND OF THE INVENTION

It is well known to control inflow profiles along wellbores of oil and gas wells to improve extraction efficiencies and prevent coning. One type of conventional inflow control device comprises apertures formed in production tubing at different downhole locations, wherein the diameter of the apertures is selected so as to provide a desired inflow profile along a wellbore. However, such known inflow control devices may be problematic especially for low flow rates because, to provide a desired pressure drop at any downhole location may require the use of an aperture diameter which may be so small as to be susceptible to blocking by particulates and/or susceptible to flow-induced erosion. Furthermore, it is well known that small aperture diameters may result in the formation of so-called “tight” emulsions comprising oil droplets which are so small and which are so well dispersed within the production fluid so as to make subsequent separation of the oil and downstream refining of the production fluid more difficult, more time consuming and/or more expensive.

Alternative inflow control devices use friction to create a pressure drop, which spreads the energy dissipation over a longer length and does not encourage the formation of tight emulsions. However, the friction based devices are not optimum for more viscous oil applications typically associated with emulsion formation, because the flow restriction and, therefore, the pressure drop provided by such devices, is sensitive to viscosity which reduces the ability of such devices to preferentially choke water.

Other known inflow control devices address the afore-mentioned problems of blockage, erosion and emulsification by introducing a tortuous or labyrinth fluid flow path. Such inflow control devices may define a flow restriction which is fixed on manufacture and which is not user configurable thus necessitating the manufacture of a range of inflow control devices so as to provide a range of flow restrictions for use along one or more wellbores. This may require an operator to stock of a range of inflow control devices causing inventory and logistical problems which may be exacerbated when storage space is limited as often is the case, for example, on offshore oil and gas platforms. Alternatively, inflow control devices comprising a labyrinth fluid flow path are known which are user configurable when located downhole. For example, U.S. Pat. No. 7,789,145 discloses a variable inflow control device which comprises a stack of spinner flow discs which provides a number of momentum changes. The number of momentum changes and/or the flow resistance may be changed while the inflow control device is deployed downhole. However, such an inflow control device is relatively complex and may be expensive to manufacture and/or operate.

### SUMMARY

Described herein in one aspect is a method for use in controlling fluid flow comprising the steps of:

sealingly mounting a flow control ring onto a base pipe;

at least partially inserting a flow restriction member into a flow control port defined by the flow control ring so as to at least partially define a predetermined flow restriction through the flow control ring; and

sealingly mounting a housing onto the flow control ring.

The method may comprise permitting fluid to flow through the flow restriction.

Such a method may provide a simple, robust and flexible method for use in controlling fluid flow.

It should be understood that the steps may be performed in any order. For example, the step of at least partially inserting the flow restriction member into the flow control port may precede the step of sealingly mounting the flow control ring onto the base pipe.

The steps may at least partially overlap.

The method may comprise adjusting the flow restriction member within the flow control port so as to adjust the flow restriction.

The method may comprise removably inserting the flow restriction member in the flow control port. For example, the method may comprise forcing the flow restriction member into the flow control port with sufficient force so as to provide an interference fit therebetween and retain the flow restriction member in the flow control port during normal operations but which permits subsequent removal of the flow restriction member from the flow control port, for example, by pulling the flow restriction member from the flow control port. This may permit subsequent removal of the flow restriction member from the flow control port so as to adjust flow restriction through the flow control ring.

The method may comprise removably mounting the housing onto the flow control ring. This may permit subsequent removal of the housing to provide access to the flow restriction member and the flow control port for the adjustment of the flow restriction member within the flow control port and/or removal of the flow restriction member from the flow control port so as to adjust flow restriction through the flow control ring.

The method may comprise permitting fluid to flow through the flow restriction and into the base pipe.

The method may comprise selecting the flow restriction so as to provide a desired pressure drop when fluid is permitted to flow through the flow restriction.

The method may comprise deploying the housing, the flow control ring, the flow restriction member and the base pipe downhole and/or along tubular infrastructure.

Such a method may permit configuration of a flow restriction after manufacture of the flow restriction member and the flow control ring. Such a method may permit a user to configure the flow restriction, for example, at or near a point of use such as at or near a wellhead of an oil or gas well.

Such a method may be used to control an inflow profile along an oil or gas well for improved extraction efficiency and/or to reduce coning.

The method may comprise welding, bonding, coupling or otherwise joining the flow control ring to an outer surface of the base pipe so as to form a seal therewith.

The method may comprise at least partially inserting the flow restriction member into the flow control port so as to at least partially define a predetermined flow restriction through the flow control ring during assembly of a flow control device, for example, at or near a wellhead

The flow control ring may define a plurality of flow control ports, each flow control port being configured to receive a corresponding flow restriction member.

The method may comprise inserting a flow restriction member at least partially into at least one of the flow control ports so as to at least partially define the predetermined flow restriction.

The use of a plurality of flow control ports may provide additional flexibility and provide a greater flow restriction range.

The method may comprise inserting a flow restriction member at least partially into a corresponding flow control port so as to occlude the flow control port and thereby at least partially define the predetermined flow restriction. It may be relatively easy and fast to occlude a flow control port using a flow restriction member. For example, the flow restriction member may be pressed, screw coupled, welded, bonded or otherwise joined to the flow control ring so as to occlude the flow control port.

The method may comprise at least partially inserting one flow restriction member into each of a plurality of the flow control ports so as to occlude said flow control ports and thereby at least partially define the predetermined flow restriction. The insertion of flow restriction members into each of a plurality of the flow control ports so as to occlude said flow control ports may provide additional flexibility in the degree of flow restriction.

The method may comprise:

axially separating a plurality of flow control rings along a base pipe and sealingly mounting the flow control rings along the base pipe;

at least partially inserting a flow restriction member into a flow control port of at least one of the flow control rings so as to at least partially define a predetermined flow restriction through the plurality of flow control rings; and

sealingly mounting the housing onto the flow control rings.

Such a method may provide a distributed restrictive geometry for flow control which is less susceptible to blocking by particulates and/or less susceptible to flow-induced erosion. Such a method may provide a flow restriction which reduces emulsification. Such a method may provide a flow restriction which is relatively insensitive to fluid viscosity.

Within each flow control ring the separately tailored allowing full design flexibility.

Such a method allows the effective diameter of the flow control ports to be reduced by increasing the number or rings. In applications where the formation of tight emulsions is a concern, larger flow control ports may be used and the number of flow control rings may be increased to reduce the energy dissipation at each flow control port.

The method may comprise coaxially aligning a flow control port of one of the flow control rings with a flow control port of another flow control ring.

Each flow control ring may have an identical arrangement of flow control ports, each flow control port being configured to receive a corresponding flow restriction member.

The method may comprise coaxially aligning the flow control ports of one flow control ring with the flow control ports of another flow control ring.

The method may comprise offsetting an axis of a flow control port of one of the flow control rings relative to an axis of a flow control port of another flow control ring. Such a method may provide a labyrinth flow path which provides additional flexibility for configuring flow restriction.

The method may comprise offsetting axes of the flow control ports of one flow control ring relative to axes of flow control ports of another flow control ring.

The method may comprise rotating one of the flow control rings within the housing relative to another flow control ring.

The method may comprise:

axially distributing a plurality of flow control rings along a base pipeline and sealingly mounting the flow control rings onto the base pipeline;

at least partially inserting a flow restriction member into a flow control port of at least one of the flow control rings so as to at least partially define a respective predetermined flow restriction through each of the flow control rings; and

sealingly mounting a corresponding housing on each flow control ring.

The method may comprise selecting the predetermined flow restrictions so as to provide a plurality of axially distributed predetermined pressure drops.

The method may comprise selecting the predetermined flow restrictions so as to provide a plurality of axially distributed fluid flow rates.

The method may comprise selecting the predetermined flow restrictions so as to equalise the fluid flow rates through the flow restrictions.

Such a method may be used to control an inflow profile along an oil or gas well for improved extraction efficiency and/or to reduce coning.

Disclosed herein in a second aspect is a flow control device comprising a housing, a flow restriction member, and a flow control ring defining a flow control port which is configured to receive the flow restriction member, wherein the flow control ring is configured so as to be sealingly mounted onto a base pipe, the flow restriction member is at least partially inserted into the flow control port so as to at least partially define a predetermined flow restriction through the flow control ring and the housing is sealingly mounted on the flow control ring.

The flow control ring may be configured so as to be welded, bonded, coupled or otherwise joined to an outer surface of a base pipe so as to form a seal therewith.

The flow restriction member and/or flow port may be configured so as to permit adjustment of the flow restriction.

The flow restriction member may be removably inserted in the flow control port. For example, the flow restriction member may be inserted into the flow control port with sufficient force so as to provide an interference fit therebetween which is sufficient to retain the flow restriction member in the flow control port during normal operations but which permits subsequent removal of the flow restriction member from the flow control port, for example, by pulling the flow restriction member from the flow control port. This may permit subsequent removal of the flow restriction member from the flow control port so as to adjust flow restriction through the flow control ring.

The housing may be removably mounted on the flow control ring. This may permit subsequent removal of the housing to provide access to the flow restriction member and the flow control port for the adjustment of the flow restriction member within the flow control port and/or removal of the flow restriction member from the flow control port so as to adjust flow restriction through the flow control ring.

The flow control ring may define a plurality of flow control ports, each flow control port being configured to receive a corresponding flow restriction member and a flow restriction member is at least partially inserted into at least one flow control port so as to at least partially define the predetermined flow restriction.

The flow control ports may be distributed circumferentially around the flow control ring.

The flow control ports may have a uniform circumferential distribution around the flow control ring.

The flow control device may comprise at least one flow restriction member, wherein a flow restriction member is at least partially inserted into at least one flow control port so as to occlude the flow control port and thereby at least partially define the predetermined flow restriction.

A flow restriction member may be at least partially inserted into each of a plurality of flow control ports so as to occlude said flow control ports and thereby at least partially define the predetermined flow restriction.

The flow control device may comprise at least one flow restriction member and a plurality of flow control rings. Each flow control ring may define a flow control port which is configured to receive a corresponding flow restriction member. The housing may be being sealingly mounted onto each flow control ring. The flow control rings may be configured so as to be axially separated along a base pipe and sealingly mounted onto the base pipe. A flow restriction member may be at least partially inserted into a flow control port of at least one of the flow control rings so as to at least partially define a predetermined flow restriction through the plurality of flow control rings.

A flow control port of one of the flow control rings may be coaxially aligned with a flow control port of another flow control ring.

Each flow control ring may have an identical arrangement of flow control ports, each flow control port being configured to receive a corresponding flow restriction member, and the flow control ports of one flow control ring are coaxially aligning with the flow control ports of another flow control ring.

A flow control port of one of the flow control rings may have an axis which is offset relative to an axis of a flow control port of another flow control ring.

Each flow control ring may have an identical arrangement of flow control ports, each flow control port being configured to receive a corresponding flow restriction member, and the flow control ports of one of the flow control rings have axes which are offset relative to axes of the flow control ports of another flow control ring.

The flow control port may be configured to be resistant to flow-induced erosion.

The flow control port may be lined with erosion resistant material.

The flow control port may be lined with tungsten carbide.

The flow control device may comprise an erosion resistant liner fitted in the flow control port.

It should be understood that one or more of the optional features disclosed in relation to the first aspect may apply alone or in any combination in relation to the second aspect and vice versa.

A third aspect disclosed herein is a flow control system comprising a base pipe, a flow restriction member, a flow control ring defining a flow control port which is configured to receive the flow restriction member, and a housing, wherein the flow control ring is sealingly mounted on the base pipe, the flow restriction member is at least partially inserted into the flow control port so as to at least partially define a predetermined flow restriction through the flow control ring, and the housing is sealingly mounted on the flow control ring.

It should be understood that one or more of the optional features disclosed in relation to the first and second aspects may apply alone or in any combination in relation to the third aspect.

Disclosed herein according to a fourth aspect is a flow control system comprising a base pipeline and a plurality of flow control devices axially distributed along the base pipeline, wherein each flow control device comprises a flow restriction member, a flow control ring defining a flow control port which is configured to receive the flow restriction member, and a housing, the flow control ring of each flow control device being sealingly mounted on the base pipeline, the flow restriction member of each flow control device being at least partially inserted into the flow control port so as to at least partially define a predetermined flow restriction through the flow control ring, and the housing of each flow control device being sealingly mounted on the corresponding flow control ring.

It should be understood that one or more of the optional features disclosed in relation to the first and second, and third aspects may apply alone or in any combination in relation to the fourth aspect.

### BRIEF DESCRIPTION OF THE DRAWINGS

The foregoing aspects will now be described by way of non-limiting example only with reference to the following drawings of which:

FIG. 1 shows a flow control device according to an embodiment of the invention prior to assembly on a base pipe;

FIG. 2(a) is a schematic longitudinal cross-section of the flow control device of FIG. 1 after assembly on a base pipe;

FIG. 2(b) is a schematic cross-section on AA of the flow control device of FIG. 2(a); and

FIG. 3 is a schematic of flow control system comprising three flow control devices each of the same type as the flow control device of FIG. 1 in use downhole during production of fluid from subterranean hydrocarbon bearing formations.

### DETAILED DESCRIPTION OF THE DRAWINGS

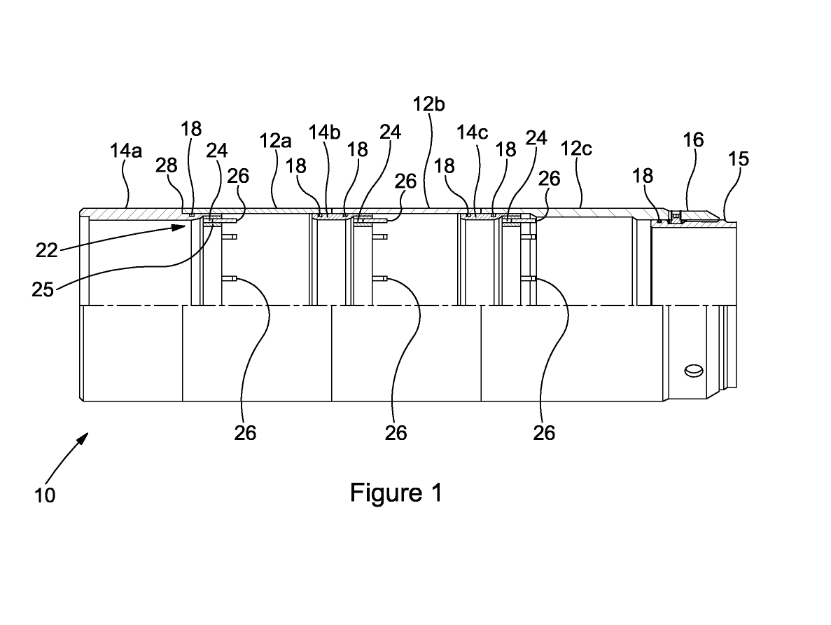

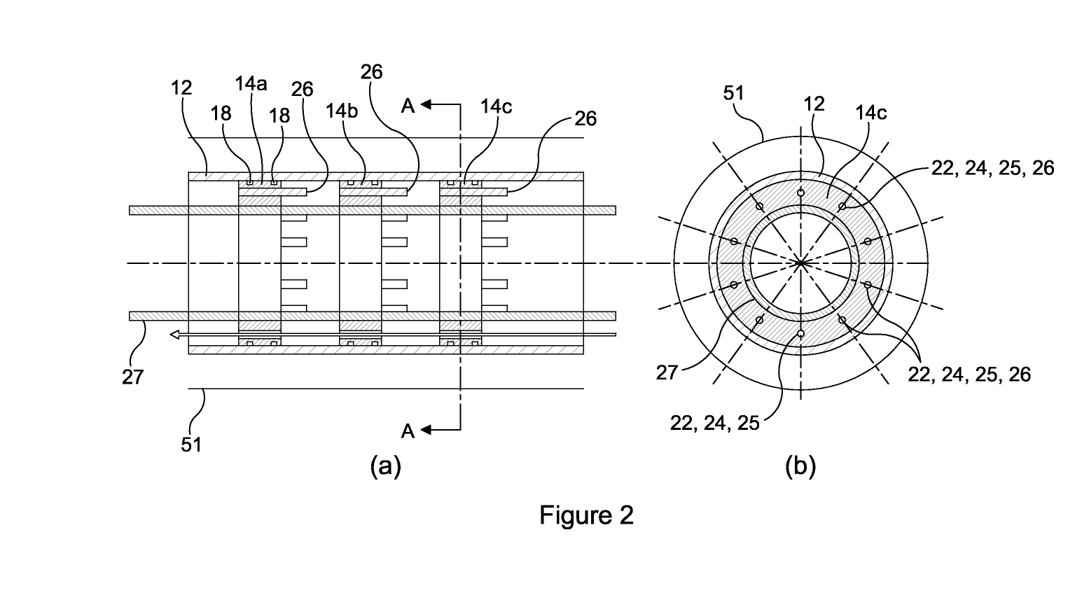

Referring initially to FIG. 1, there is provided a flow control device generally designated 10. Although not shown in FIG. 1, it should be understood that flow control device 10 is assembled on a base pipe as will be described in more detail below with reference to FIGS. 2(a) and 2(b). The flow control device 10 comprises a tubular housing generally designated 12, first, second and third flow control rings 14a, 14b and 14c, an attachment ring 15 and a locking ring 16. For ease of assembly, the housing 12 comprises first, second and third tubular sections 12a, 12b and 12c which are coaxially aligned in end-to-end relation. Each flow control ring 14a, 14b, 14c carries one or more respective O-ring seals 18 on an outer diameter thereof.

As shown more clearly in FIGS. 2(a) and 2(b), each flow control ring 14a defines ten circumferentially distributed flow control ports 22. Each flow control port 22 comprises a corresponding aperture 24 shown most clearly in FIG. 1 formed in the corresponding flow control ring 14a, 14b, 14c and a corresponding erosion resistant tungsten carbide liner 25 press fitted into the corresponding aperture 24. Each flow control port 22 is configured to receive a corresponding rod-like flow restriction member 26. The flow control ports 22 of the flow control rings 14a, 14b, 14c are identically arranged. It should be understood that, for ease of illustration, the flow control ports 22 of the flow control rings 14a, 14b, 14c are shown in FIGS. 1 and 2(a) as being rotationally aligned within the housing 12 such that corresponding flow control ports 22 of each flow control ring 14a, 14b, 14c are in general coaxial alignment but that, in general, the flow control ports 22 of each flow control ring 14a, 14b, 14c may be mis-aligned.

As shown schematically in FIGS. 2(a) and 2(b), the flow control device 10 is assembled on a base pipe 27 by welding the respective inner diameters of the flow control rings 14a, 14b, 14c and the attachment ring 15 to an outer diameter of the base pipe 27. The flow control rings 14a, 14b, 14c and the attachment ring 15 are positioned and welding to the base pipe 27 such that the axial separation between control rings 14a, 14b corresponds to an axial extent of the housing section 12a, the axial separation between control rings 14b, 14c corresponds to an axial extent of the housing section 12b, and the axial separation between control ring 14c and attachment ring 15 corresponds to an axial extent of the housing section 12c.

Once the flow control rings 14a, 14b, 14c and the attachment ring 15 are welded to the base pipe 27, one or more flow restriction members 26 are at least partially inserted into and then held in engagement with one or more flow control ports 22 of at least one of the flow control rings 14a, 14b, 14c so as to occlude the flow of fluid through said one or more flow control ports 22. One skilled in the art will appreciate that the flow control ports 22 of the flow control rings 14a, 14b, 14c may collectively define a flow restriction through the flow control rings 14a, 14b, 14c which may be varied according to the number and/or arrangement of the flow restriction members 26 inserted into the flow control rings 14a, 14b, 14c. The flow restriction may be selected so as to provide a desired flow performance defined in terms of a desired pressure drop across the flow control device 10 and maximum emulsification and erosion levels as will be described in more detail below. It should also be understood that a flow restriction member 26 may be held in engagement with the flow control port 22 by pressing, screw coupling, welding, bonding or any other suitable joining technique.

With the appropriate number and/or arrangement of flow restriction members 26 inserted into the flow control ports 22 of the flow control rings 14a, 14b, 14c, the first housing section 12a is slipped over the outer diameters of the flow control rings 14a, 14b, 14c such that a first end of the first housing section 12a (the left hand end of the first housing section 12a as illustrated in FIG. 1) engages a shoulder 28 formed on an outer diameter of the first flow control ring 14a. This results in sealing engagement of an O-ring seal 18 carried by the first flow control ring 14a against an internal diameter of the first housing section 12a at the first end of the first housing section 12a and sealing engagement of an O-ring seal 18 carried by the second flow control ring 14b against an internal diameter of the first housing section 12a at second end of the first housing section 12a (the right hand end of the first housing section 12a as illustrated in FIG. 1). Similarly, the second housing section 12b is slipped over the outer diameters of the second and third flow control rings 14b, 14c such that a first end of the second housing section 12b engages the second end of the first housing section 12a and O-ring seals 18 carried by the second and third flow control rings 14b, 14c sealingly engage an internal diameter of the second housing section 12b at opposite ends thereof. Similarly, the third housing section 12c is slipped over the outer diameter of the third flow control ring 14c such that a first end of the third housing section 12c engages the second end of the second housing section 12b and O-ring seals 18 carried by the second flow control ring 14c and the attachment ring 15 sealingly engage an internal diameter of the third housing section 12c at opposite ends thereof. Assembly is completed by screw coupling the locking nut 16 onto a male threaded portion formed on an outer surface of the attachment ring 15.

It should be understood that the order of assembly described above not only simplifies assembly of the housing sections 12a, 12b, and 12c, but also permits disassembly of the housing sections 12a, 12b, and 12c to provide access to the flow control rings 14a, 14b, 14c for re-configuration of the flow restriction members 26 to alter the flow restriction characteristics provided by the flow control device 10 and to permit re-assembly of the flow control device 10 for further use. As such, the flow restriction members 26 may be inserted and held in engagement in the flow control ports 22 in such a manner as to be adjustable, removable and/or replaceable. For example, the flow restriction members 26 may be screw coupled into the flow control ports 22.

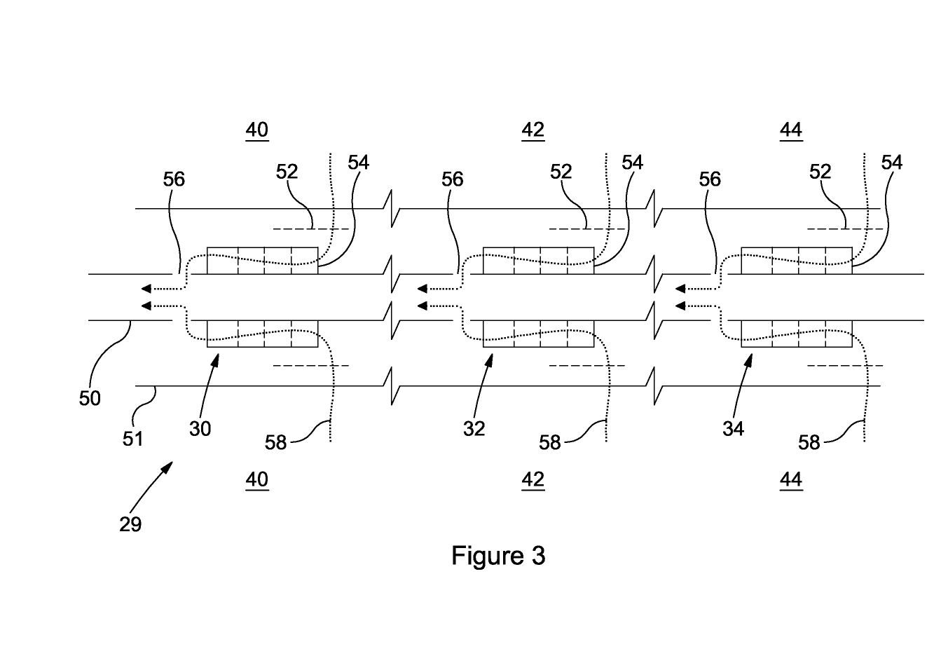

FIG. 3 shows a flow control system generally designated 29 comprising three flow control devices 30, 32 and 34 which are each of the same type as the flow control device 10 shown in FIGS. 1, 2(a) and 2(b) in use downhole during production of fluid from subterranean hydrocarbon bearing formations 40, 42 and 44 respectively. The flow control devices 30, 32 and 34 are mounted on a base pipeline 50 which extends within a wellbore 51. The base pipeline 50 may comprise one or more lengths of base pipe 27. A respective filter or screen 52 is located adjacent to the respective downhole ends 54 of the flow control devices 30, 32 and 34 such that fluid flowing from the formations 40, 42 and 44 passes through the respective screens 52 before entering the respective flow control devices 30, 32 and 34 through the respective annular apertures 54 at the respective downhole ends thereof. The base pipeline 50 has a respective plurality of base pipe ports 56 formed therein at respective positions located uphole of the respective flow control devices 30, 32 and 34. The flow control devices 30, 32 and 34 are independently configured to independently control the flow of fluid from the formations 40, 42 and 44 through the respective screens 52 into the base pipe 50 towards a wellhead (not shown) as illustrated by the arrows 58. One skilled in the art will appreciate that the wellbore 51 may comprise an openhole section or a section of perforated casing. Furthermore, although the wellbore 51 is shown in a horizontal orientation in FIG. 3, it should be understood that the wellbore 51 could have a vertical orientation or any intermediate orientation between horizontal and vertical.

In use, the flow control devices 30, 32 and 34 are independently configured during assembly by selecting the number and/or arrangement of the flow restriction members 26 in the flow control ports 22 of each flow control ring 14a, 14b and 14c of each flow control device 30, 32 and 34 so as to provide predetermined respective flow restrictions to fluid flowing through each flow control device 30, 32 and 34. The respective flow restrictions are selected to provide predetermined respective pressure drops for fluid flowing from the respective formations 40, 42 and 44 through the respective screens 52 and the respective flow control devices 30, 32 and 34 into the base pipeline 50. In one mode of use, the flow restrictions may be selected to provide predetermined respective pressure drops required to provide a desired inflow profile along the base pipeline 50. For example, the flow restrictions may be selected to provide predetermined respective pressure drops required to equalise the fluid flow rates from the formations 40, 42 and 44 through the respective screens 52 into the base pipeline 50. It should be understood that the diameter of the flow control ports 22 is sufficiently great so as reduce the risk of blockage and/or reduce erosion by particulates or the like which pass through the screens 52 whilst also preventing the formation of emulsions comprising oil droplets which are unacceptably small.

One skilled in the art will understand that various modifications of the foregoing embodiments are possible. For example, the flow control members and/or the flow control ports may be configured such that insertion of a flow control member into a flow control port only partially restricts the flow of fluid through the flow control port. It should be understood that FIGS. 1, 2(a) and 2(b) show one particular arrangement of nine flow restriction members 26 inserted in nine of ten flow control ports 22 so as to leave one open flow control port per flow control ring. However, the number and/or arrangement of flow restriction members inserted in the flow control ports of each flow control ring may be different from that shown in FIGS. 1, 2(a) and 2(b). One or more of the flow control rings may have an identical number and/or arrangement of flow control ports. Different flow control rings may have different numbers and/or arrangements of flow control ports.

There may be more or fewer than three flow control rings per flow control device. To increase the pressure drop provided by a particular flow control device, the number of flow control rings may be increased and/or the number of open flow control ports per ring may be reduced. Conversely, to decrease the pressure drop provided by a particular flow control device, the number of flow control rings may be decreased and/or the number of open flow control ports per ring may be increased.

The relative dimensions of the any of the features of the flow control device may be different to those illustrated in any of FIGS. 1, 2, 3(a) and 3(b). For example, the relative separation of the flow control rings may be larger or smaller than illustrated. The relative sizes of the flow control ports may be greater or smaller than illustrated.

The flow control rings may be rotationally aligned and locked so as to prevent further rotation relative to the housing. This may provide a further degree of control of the flow restriction provided by the flow control device. The flow control rings may be rotationally aligned such that one or more corresponding flow ports 22 of each flow control ring 14a, 14b, 14c are held in general coaxial alignment by the housing 12. The flow control rings 14a, 14b, 14c may be rotationally aligned for coaxial alignment of their respective flow ports 22 and prevented from rotation relative to one another within the housing 12 by means of a key and keyway arrangement. Alternatively, the flow control rings may be rotated and then locked such that an axis of a flow port 22 of one flow control ring is rotationally mis-aligned relative to an axis of a flow port 22 of a different flow control ring thereby providing a predetermined lateral offset between the respective axes of the flow ports 22. Where two flow control rings have an identical number and/or arrangement of flow control ports, this may lead to an identical rotational mis-alignment between corresponding flow control ports.

Although the foregoing embodiment of the flow control device is described for the control of fluid flow from the formations 40, 42 and 44 into the base pipeline 50 in the context of hydrocarbon fluid production, the flow control device may be used for the injection of fluids, chemicals, particulates or the like from the base pipeline 50 into the formations 40, 42 and 44 in the context of well intervention for the stimulation of subsequent production.

1. A method for use in controlling fluid flow comprising:
sealingly mounting a flow control ring onto a base pipe;
at least partially inserting a flow restriction member into a flow control port defined by the flow control ring so as to at least partially define a predetermined flow restriction through the flow control ring; and
sealingly mounting a housing onto the flow control ring.

2. A method for use in controlling fluid flow according to claim 1, comprising:
permitting fluid to flow through the flow restriction.

3. A method for use in controlling fluid flow according to claim 2, comprising:
permitting fluid to flow into the housing, through the flow restriction and into the base pipe.

4. A method for use in controlling fluid flow according to claim 1, comprising:
welding, bonding, coupling or otherwise joining the flow control ring to an outer surface of the base pipe so as to form a seal therewith.

5. A method for use in controlling fluid flow according to claim 1, comprising:
selecting the flow restriction so as to provide a desired pressure drop when fluid is permitted to flow through the flow restriction.

6. A method for use in controlling fluid flow according to claim 1, comprising:
deploying the housing, the flow control ring, the flow restriction member and the base pipe downhole and/or along tubular infrastructure.

7. A method for use in controlling fluid flow according to claim 1, wherein the flow control ring defines a plurality of flow control ports, each flow control port being configured to receive a corresponding flow restriction member, and the method comprises:
inserting a flow restriction member at least partially into at least one of the flow control ports so as to at least partially define the predetermined flow restriction.

8. A method for use in controlling fluid flow according to claim 7, comprising:
inserting a flow restriction member at least partially into a corresponding flow control port so as to occlude the flow control port and thereby at least partially define the predetermined flow restriction.

9. A method for use in controlling fluid flow according to claim 7, comprising:
at least partially inserting one flow restriction member into each of a plurality of the flow control ports so as to occlude said flow control ports and thereby at least partially define the predetermined flow restriction.

10. A method for use in controlling fluid flow according to claim 1, comprising:
axially separating a plurality of flow control rings along a base pipe and sealingly mounting the flow control rings along the base pipe;
at least partially inserting a flow restriction member into a flow control port of at least one of the flow control rings so as to at least partially define a predetermined flow restriction through the plurality of flow control rings; and
sealingly mounting the housing onto the flow control rings.

11. A method for use in controlling fluid flow according to claim 10, comprising:
coaxially aligning a flow control port of one of the flow control rings with a flow control port of another flow control ring.

12. A method for use in controlling fluid flow according to claim 10, wherein each flow control ring has an identical arrangement of flow control ports, each flow control port being configured to receive a corresponding flow restriction member, and the method comprises:
coaxially aligning the flow control ports of one flow control ring with the flow control ports of another flow control ring.

13. A method for use in controlling fluid flow according to claim 10, comprising:
offsetting an axis of a flow control port of one of the flow control rings relative to an axis of a flow control port of another flow control ring.

14. A method for use in controlling fluid flow according to claim 10, wherein each flow control ring has an identical arrangement of flow control ports, each flow control port being configured to receive a corresponding flow restriction member, and the method comprises:
offsetting axes of the flow control ports of one flow control ring relative to axes of flow control ports of another flow control ring.

15. A method for use in controlling fluid flow according to any of claim 10, comprising:
rotating one of the flow control rings within the housing relative to another flow control ring.

16. A method for use in controlling fluid flow according to claim 1, comprising:
axially distributing a plurality of flow control rings along a base pipeline and sealingly mounting the flow control rings onto the base pipeline;
at least partially inserting a flow restriction member into a flow control port of at least one of the flow control rings so as to at least partially define a respective predetermined flow restriction through each of the flow control rings; and
sealingly mounting a corresponding housing on each flow control ring.

17. A method for use in controlling fluid flow according to claim 16, comprising:
selecting the predetermined flow restrictions so as to provide a plurality of axially distributed predetermined pressure drops.

18. A method for use in controlling fluid flow according to claim 16, comprising:
selecting the predetermined flow restrictions so as to provide a plurality of axially distributed fluid flow rates.

19. A method for use in controlling fluid flow according to any of claim 16, comprising:
selecting the predetermined flow restrictions so as to equalise the fluid flow rates through the flow restrictions.

20. A flow control device comprising a housing, a flow restriction member, and a flow control ring defining a flow control port which is configured to receive the flow restriction member, wherein the flow control ring is configured so as to be sealingly mounted onto a base pipe, the flow restriction member is at least partially inserted into the flow control port so as to at least partially define a predetermined flow restriction through the flow control ring and the housing is sealingly mounted on the flow control ring.

21. A flow control device according to claim 20, wherein the flow control ring is configured so as to be welded, bonded, coupled or otherwise joined to an outer surface of a base pipe so as to form a seal therewith.

22. A flow control device according to claim 20, wherein the flow control ring defines a plurality of flow control ports, each flow control port being configured to receive a corresponding flow restriction member and a flow restriction member is at least partially inserted into at least one flow control port so as to at least partially define the predetermined flow restriction.

23. A flow control device according to claim 22, wherein the flow control ports are distributed circumferentially around the flow control ring.

24. A flow control device according to claim 22, wherein the flow control ports have a uniform circumferential distribution around the flow control ring.

25. A flow control device according to claim 22 comprising at least one flow restriction member, wherein a flow restriction member is at least partially inserted into at least one flow control port so as to occlude the flow control port and thereby at least partially define the predetermined flow restriction.

26. A flow control device according to claim 22, wherein a flow restriction member is at least partially inserted into each of a plurality of flow control ports so as to occlude said flow control ports and thereby at least partially define the predetermined flow restriction.

27. A flow control device according to claim 20, comprising at least one flow restriction member and a plurality of flow control rings, each flow control ring defining a flow control port which is configured to receive a corresponding flow restriction member, the housing being sealingly mounted onto each flow control ring and the flow control rings being configured so as to be axially separated along a base pipe and sealingly mounted onto the base pipe, wherein a flow restriction member is at least partially inserted into a flow control port of at least one of the flow control rings so as to at least partially define a predetermined flow restriction through the plurality of flow control rings.

28. A flow control device according to claim 27, wherein a flow control port of one of the flow control rings is coaxially aligned with a flow control port of another flow control ring.

29. A flow control device according to claim 27, wherein each flow control ring has an identical arrangement of flow control ports, each flow control port being configured to receive a corresponding flow restriction member, and the flow control ports of one flow control ring are coaxially aligned with the flow control ports of another flow control ring.

30. A flow control device according to claim 27, wherein a flow control port of one of the flow control rings has an axis which is offset relative to an axis of a flow control port of another flow control ring.

31. A flow control device according to claim 27, wherein each flow control ring has an identical arrangement of flow control ports, each flow control port being configured to receive a corresponding flow restriction member, and the flow control ports of one of the flow control rings have axes which are offset relative to axes of the flow control ports of another flow control ring.

32. A flow control device according to claim 20, wherein the flow control port is configured to be resistant to flow-induced erosion.

33. A flow control device according to claim 32, wherein the flow control port is lined with erosion resistant material.

34. A flow control device according to claim 32, wherein the flow control port is lined with tungsten carbide.

35. A flow control device according to claim 32, comprising an erosion resistant liner fitted in the flow control port.

36. A flow control system comprising a flow control device according to claim 20 and a base pipe, wherein the flow control ring is sealingly mounted on the base pipe.

37. A flow control system comprising a plurality of flow control devices according to claim 20, wherein the flow control devices are axially distributed along and sealingly mounted on a base pipeline.
